(19) United States
(12) Patent Application Publication
(10) Pub. No.: US 2026/0153085 A1
(43) Pub. Date: Jun. 4, 2026

(54) ENERGY RECOVERY TYPE SCROLL COMPRESSOR AND CARBON DIOXIDE HEAT PUMP SYSTEM USING SAME

(71) Applicant: PUREIS TECHNOLOGY (HUBEI) CO., LTD, YICHANG (CN)

(72) Inventor: SHENGPING FAN, YICHANG (CN)

(21) Appl. No.: 18/697,705

(22) PCT Filed: Dec. 25, 2023
(86) PCT No.: PCT/CN2023/141549

§ 371 Date: Apr. 1, 2024

(30) Foreign Application Priority Data
Nov. 15, 2023 (CN) 202311535454.4

(51) Int. Cl. F04C 18/02; F04C 29/00; F04C 29/02; F25B 30/02

(52) U.S. Cl. CPC F04C 18/0207; F04C 29/0042; F04C 29/02; F25B 30/02

(57) ABSTRACT

An energy recovery type scroll compressor and a carbon dioxide heat pump system using the same are provided, which relate to the technical field of compressors. The energy recovery type scroll compressor includes a scroll compression mechanism, a driving mechanism and a scroll expansion mechanism. One end of a motor shaft of the driving mechanism is in transmission connection with the scroll compression mechanism, and the other end of the motor shaft of the driving mechanism is in transmission connection with the scroll expansion mechanism. The motor shaft of a driving motor is in transmission connection with a loaded scroll plate of the scroll expansion mechanism. An air intake hollow shaft is arranged at one end, away from the loaded scroll plate, of an unloaded scroll plate of the scroll expansion mechanism. An air inlet communicates with an expansion end high-pressure working medium channel.

### CROSS REFERENCE TO RELATED APPLICATION

This application is a national stage application of International Patent Application No. PCT/CN2023/141549, filed on Dec. 25, 2023, which claims the priority of Chinese Patent Application No. 202311535454.4 entitled “ENERGY RECOVERY TYPE SCROLL COMPRESSOR AND CARBON DIOXIDE HEAT PUMP SYSTEM USING SAME” filed with the Chinese Patent Office on Nov. 15, 2023, which is incorporated herein by reference in its entirety.

### TECHNICAL FIELD

The present disclosure relates to the technical field of compressors, in particular to an energy recovery type scroll compressor and a carbon dioxide heat pump system using the same.

### BACKGROUND

The scroll compressor has the advantages such as simple structure, stable operation, low noise, high mechanical efficiency and high volumetric efficiency, and is widely used in various fields such as industry and life. The dynamic and static scroll plates of the scroll compressor are arranged relative to each other by the difference of 180 degrees, and are assembled by offsetting a determined revolution radius. The dynamic scroll plate is driven by the crankshaft with an eccentric radius as a revolution radius to realize revolution and translation. During the movement, the dynamic scroll plate is meshed with the static scroll plate to form several crescent-shaped closed working cavities with continuously changing volumes, which are respectively the first (central cavity), second and third compression cavities (air suction cavities) from inside to outside. When the compressor works, the volume of the compression cavity changes with the spindle rotation angle. When the compression is finished, the second compression cavity communicates with the central cavity, and the gas is exhausted through the exhaust hole. The working medium is subjected to three processes such as air suction, compression and exhaust in the crescent working cavity.

The scroll compressor is widely used in the field of heat pump air conditioning. As a new technology with high efficiency, energy saving and environmental protection, the transcritical carbon dioxide cycle heat pump is widely developed and applied because of no pollution or damage to the environment, stable system operation, compact equipment and high system energy efficiency ratio. However, due to the high operating pressure of the transcritical carbon dioxide cycle heat pump, the throttling pressure difference between the high pressure side and the low pressure side can reach 6-8 Mpa. Therefore, there is still a problem of large throttling loss at present for the transcritical carbon dioxide cycle heat pump.

Thus, people urgently need an energy recovery type scroll compressor which can recover the throttling energy, reduce the energy consumption and improve the energy utilization rate.

### SUMMARY

The embodiments aim to provide an energy recovery type scroll compressor and a carbon dioxide heat pump system using the same. A scroll expansion mechanism is driven to move by applying a high-pressure working medium, and a motor shaft of a driving mechanism is driven to move, such that the pressure energy of the high-pressure working medium can be recovered and utilized, the energy consumption of the driving mechanism is reduced, and the energy utilization rate is improved.

In order to achieve the above-mentioned purposes, the present disclosure provides the following solution. The present disclosure provides an energy recovery type scroll compressor and a carbon dioxide heat pump system using the same. The energy recovery type scroll compressor includes a scroll compression mechanism, a driving mechanism and a scroll expansion mechanism, wherein one end of a motor shaft of the driving mechanism is in transmission connection with the scroll compression mechanism, and an other end of the motor shaft of the driving mechanism is in transmission connection with the scroll expansion mechanism, the scroll expansion mechanism comprises a loaded scroll plate and an unloaded scroll plate, the motor shaft of the driving mechanism is in transmission connection with the loaded scroll plate, an air intake hollow shaft centrally provided with an air inlet is arranged at one end, away from the loaded scroll plate, of the unloaded scroll plate, the air inlet communicates with an expansion end high-pressure working medium channel, and an expansion cavity of the scroll expansion mechanism communicates with an expansion end low-pressure working medium channel.

In some embodiments, the expansion cavity may communicate with an inner cavity of the driving mechanism, and the expansion end low-pressure working medium channel may communicate with the expansion cavity through the inner cavity of the driving mechanism.

In some embodiments, the scroll compression mechanism, the driving mechanism and the scroll expansion mechanism may be sequentially arranged from top to bottom, and a fixed support may be arranged at a bottom of the scroll expansion mechanism.

In some embodiments, the scroll compression mechanism may be an autorotating scroll compression mechanism, and the scroll expansion mechanism may be an autorotating scroll expansion mechanism.

In some embodiments, the scroll compression mechanism may include a compressor pressure-stabilizing shell, a driving scroll plate, a transmission slip ring and a driven scroll plate. The compressor pressure-stabilizing shell may be arranged at one end of the driving mechanism to form a compression cavity with the driving mechanism. The driving scroll plate, the transmission slip ring and the driven scroll plate may be sequentially arranged in the compression cavity along a direction away from the driving mechanism. The driving scroll plate may be in transmission connection with the motor shaft of the driving mechanism. The driving scroll plate may be in transmission connection with the driven scroll plate through the transmission slip ring. An exhaust hollow shaft may be arranged at one end, away from the driving scroll plate, of the driven scroll plate. The exhaust hollow shaft may communicate with a high-pressure exhaust channel. The compression cavity may communicate with a low-pressure air intake channel. The exhaust hollow shaft may be arranged in the compressor pressure-stabilizing shell through a compressor bearing seat. A phase difference between the driving scroll plate and the driven scroll plate may be 180°.

A first driving friction surface and a second driving friction surface may be oppositely arranged on both sides of scroll teeth of the driving scroll plate. A first driving portion in a strip shape may be radially arranged on the first driving friction surface. A second driving portion in a strip shape may be radially arranged on the second driving friction surface. A first driven friction surface and a second driven friction surface may be oppositely arranged on both sides of scroll teeth of the driven scroll plate. A first driven portion in a strip shape may be radially arranged on the first driven friction surface. A second driven portion in a strip shape may be radially arranged on the second driven friction surface.

Two first transmission slip ring matching portions may be oppositely formed in an end face, close to the driving scroll plate, of the transmission slip ring. The two first transmission slip ring matching portions may be respectively matched with the first driving portion and the second driving portion. The end face of the transmission slip ring may be divided into a first transmission slip ring friction surface and a second transmission slip ring friction surface by the two first transmission slip ring matching portions. The first transmission slip ring friction surface may be in contact with the first driving friction surface. The second transmission slip friction surface may be in contact with the second driving friction surface. Two second transmission slip ring matching portions may be oppositely formed in an other end face, close to the driven scroll plate, of the transmission slip ring. The two second transmission slip ring matching portions may be respectively matched with the first driven portion and the second driven portion. The other end face of the transmission slip ring may be divided into a third transmission slip ring friction surface and a fourth transmission slip ring friction surface by the two second transmission slip ring matching portions. The third transmission slip ring friction surface may be in contact with the first driven friction surface. The fourth transmission slip ring friction surface may be in contact with the second driven friction surface. Multiple transmission slip ring vent holes for communicating inside with outside may be formed in the transmission slip ring along a radial direction of the transmission slip ring.

In some embodiments, each of the driving scroll plate, the transmission slip ring and the driven scroll plate may be sprayed with a self-lubricating coating.

In some embodiments, the compression cavity may be divided into a working cavity and a pressure stabilizing cavity by the bearing seat. The exhaust hollow shaft may communicate with the high-pressure exhaust channel through the pressure stabilizing cavity. The low-pressure air intake channel may communicate with the working cavity. A check valve for preventing gas from flowing backwards may be arranged on an end face, located in the pressure stabilizing cavity, of the bearing seat.

In some embodiments, the scroll expansion mechanism may include an expander pressure-stabilizing shell, the loaded scroll plate, a limit slip ring and the unloaded scroll plate. The expander pressure-stabilizing shell may be arranged at one end of the driving mechanism to form the expansion cavity with the driving mechanism. The loaded scroll plate, the limit slip ring and the unloaded scroll plate may be sequentially arranged in the expansion cavity along the direction away from the driving mechanism. The loaded scroll plate may be in transmission connection with the motor shaft of the driving mechanism. The loaded scroll plate may be in transmission connection with the unloaded scroll plate through the limit slip ring. A phase difference between the loaded scroll plate and the unloaded scroll plate may be 180°.

A first loaded friction surface and a second loaded friction surface may be oppositely arranged on both sides of scroll teeth of the loaded scroll plate. A first loaded portion in a strip shape may be radially arranged on the first loaded friction surface. A second loaded portion in a strip shape may be radially arranged on the second loaded friction surface. A first unloaded friction surface and a second unloaded friction surface may be oppositely arranged on both sides of scroll teeth of the unloaded scroll plate. A first unloaded portion in a strip shape may be radially arranged on the first unloaded friction surface. A second unloaded portion in a strip shape may be radially arranged on the second unloaded friction surface;

Two first limit slip ring matching portions may be oppositely formed in an end face, close to the loaded scroll plate, of the limit slip ring. The two first limit slip ring matching portions may be respectively matched with the first loaded portion and the second loaded portion. The end face of the limit slip ring may be divided into a first limit slip ring friction surface and a second limit slip ring friction surface by the two first limit slip ring matching portions. The first limit slip ring friction surface may be in contact with the first loaded friction surface. The second limit slip friction surface may be in contact with the second loaded friction surface. Two second limit slip ring matching portions may be oppositely formed in an other end face, close to the unloaded scroll plate, of the limit slip ring. The two second limit slip ring matching portions may be respectively matched with the first unloaded portion and the second unloaded portion. The other end face of the limit slip ring may be divided into a third limit slip ring friction surface and a fourth limit slip ring friction surface by the two second limit slip ring matching portions. The third limit slip ring friction surface may be in contact with the first unloaded friction surface. The fourth limit slip ring friction surface may be in contact with the second unloaded friction surface. Multiple limit slip ring vent holes for communicating inside with outside may be formed in the limit slip ring along a radial direction of the limit slip ring.

In some embodiments, each of the loaded scroll plate, the limit slip ring and the unloaded scroll plate may be sprayed with a self-lubricating coating.

The present disclosure also provides a carbon dioxide heat pump system using the energy recovery type scroll compressor. a regenerator high-pressure side working medium outlet of the carbon dioxide heat pump system communicates with the expansion end high-pressure working medium channel, an evaporator working medium inlet of the carbon dioxide heat pump system communicates with the expansion end low-pressure working medium channel, a regenerator low-pressure side working medium outlet of the carbon dioxide heat pump system communicates with the low-pressure air intake channel of the scroll compression mechanism, and a cooler working medium inlet of the carbon dioxide heat pump system communicates with the high-pressure exhaust channel of the scroll compression mechanism.

Compared with the prior art, the embodiments mainly have the following technical effects.

The pressure energy of the high-pressure working medium is converted into the rotation of the scroll expansion mechanism by conveying the high-pressure working medium to the scroll expansion mechanism, and then the motor shaft of the driving mechanism is driven to rotate. The energy consumption when the drive mechanism drives the scroll compression mechanism to work can be reduced. Equivalently, the pressure energy is matched with the electric energy of the driving motor to drive the scroll compression mechanism to move, such that the recovery of the pressure energy of the high-pressure working medium is realized, the power consumption of the driving mechanism is also reduced, and the energy utilization rate is improved.

Compared with the prior art, other solutions of the embodiments have the following technical effects.

The present device works instead of a throttle valve. The throttling expanded high-pressure working medium flows through the motor and absorbs the heat generated by the motor, such that the problem of motor cooling is solved. After the device is applied for a carbon dioxide heat pump, the temperature of the motor is higher than that of the outside air of the evaporator. The heat exchange efficiency through the motor is higher, and the overall heat exchange efficiency is improved. That is, the waste heat of the motor is recovered to improve the heat exchange efficiency, the working efficiency of the system is improved, and the energy consumption of the whole unit is reduced.

The energy recovery type scroll compressor is of a vertical structure. The scroll compressor is located at the upper portion of the motor, and the scroll expander is located at the lower portion of the motor. When the device is applied for a carbon dioxide heat pump, the carbon dioxide working medium is in a gas-liquid two-phase state after expansion by an expander. Due to the density difference, liquid-phase carbon dioxide is in the lower portion and gas-phase carbon dioxide is in the upper portion, such that gas-liquid separation of carbon dioxide is realized.

The self-lubricating coatings are adopted. The coatings can effectively lubricate the driving scroll plate, the driven scroll plate and the transmission slip ring of the scroll compression mechanism as well as the loaded scroll plate, the unloaded scroll plate and the limit slip ring of the scroll expansion mechanism, and the coatings can reduce the meshing clearance between the driving scroll plate and the driven scroll plate of the scroll compressor, such that the leakage rate is reduced, and the compression efficiency is improved.

### BRIEF DESCRIPTION OF THE DRAWINGS

To describe the technical solution in the embodiments of the present disclosure or in the prior art more clearly, the following briefly introduces the drawings required for describing the embodiments. Apparently, the drawings in the following description show merely some embodiments of the present disclosure, and those skilled in the art may still derive other drawings from these drawings without creative efforts.

FIG. 1 is a structural schematic diagram of the appearance of an energy recovery type scroll compressor according to the present disclosure.

FIG. 2 is a schematic cross section of arrows in FIG. 1.

FIG. 3 is a structural schematic diagram of a driving scroll plate according to the present disclosure.

FIG. 4 is a structural schematic diagram of a driven scroll plate according to the present disclosure.

FIG. 5 is a structural schematic diagram of a transmission slip ring according to the present disclosure.

FIG. 6 is a structural schematic diagram of a loaded scroll plate according to the present disclosure.

FIG. 7 is a structural schematic diagram of an unloaded scroll plate according to the present disclosure.

FIG. 8 is a structural schematic diagram of a limit slip ring according to the present disclosure.

### REFERENCE SIGNS

1, air intake hollow shaft; 2, expander bearing seat; 3, unloaded scroll plate; 301, first unloaded portion; 302, first unloaded friction surface; 303, second unloaded portion; 304, second unloaded friction surface; 4, limit slip ring; 401, first limit slip ring matching portion; 402, second limit slip ring matching portion; 403, first limit slip ring friction surface; 404, second limit slip ring friction surface; 405, third limit slip ring friction surface; 406, fourth limit slip ring friction surface; 407, limit slip ring vent hole; 5, loaded scroll plate; 501, first loaded portion; 502, first loaded friction surface; 503, second loaded portion; 504, second loaded friction surface; 6, bottom bearing seat; 701, motor stator; 702, motor rotor; 703, motor shaft; 8, motor shell; 9, driving scroll plate; 901, first driving portion; 902, first driving friction surface; 903, second driving portion; 904, second driving friction surface; 10, transmission slip ring; 1001, first transmission slip ring matching portion; 1002, second transmission slip ring matching portion; 1003, first transmission slip ring friction surface; 1004, second transmission slip ring friction surface; 1005, third transmission slip ring friction surface; 1006, fourth transmission slip ring friction surface; 1007, transmission slip ring vent hole; 11, driven scroll plate; 1101, first driven portion; 1102, first driven friction surface; 1103, second driven portion; 1104, second driven friction surface; 12, exhaust hollow shaft; 13, check valve; 14, compressor pressure-stabilizing shell; 15, expander pressure-stabilizing shell; 16, fixed support; a, expansion end high-pressure working medium channel; b, expansion end low-pressure working medium channel; c, low-pressure air intake channel; and d, high-pressure exhaust channel.

### DETAILED DESCRIPTION OF THE EMBODIMENTS

The following clearly and completely describes the technical solution in the embodiments of the present disclosure with reference to the embodiments of the present disclosure. Apparently, the described embodiments are merely a portion rather than all of the embodiments of the present disclosure. Based on the embodiment in the present disclosure, all other embodiments acquired by the ordinary technical staff in the art under the premise of without contributing creative labor belong to the scope protected by the present disclosure.

The embodiments aim to provide an energy recovery type scroll compressor and a carbon dioxide heat pump system using the same so as to solve the problems in the prior art. A scroll expansion mechanism is driven to move by using a high-pressure working medium, and then a motor shaft of a driving mechanism is driven to move, such that the pressure energy of the high-pressure working medium can be recovered and utilized, the energy consumption of the driving mechanism is reduced, and the energy utilization rate is improved.

To make the foregoing objective, features and advantages of the present disclosure clearer and more comprehensible, the present disclosure is further described in detail below with reference to the drawings and specific embodiments.

### Embodiment I

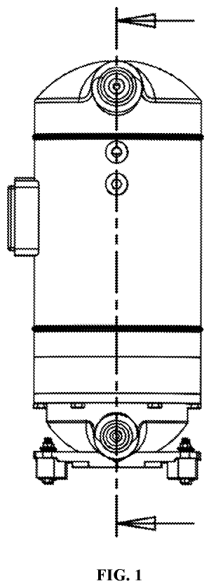

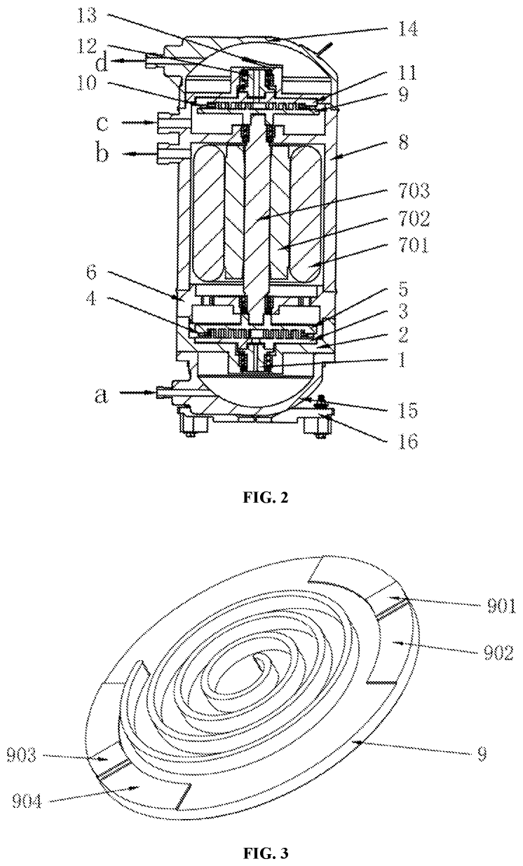

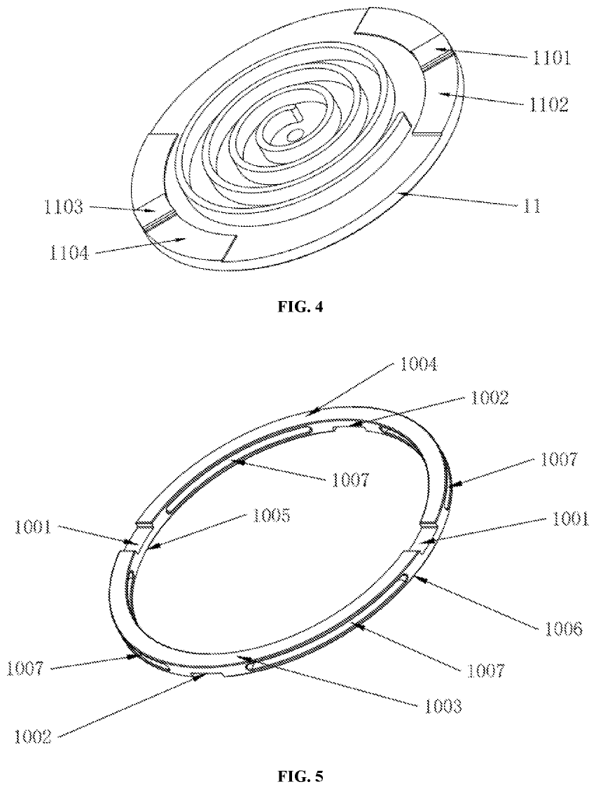

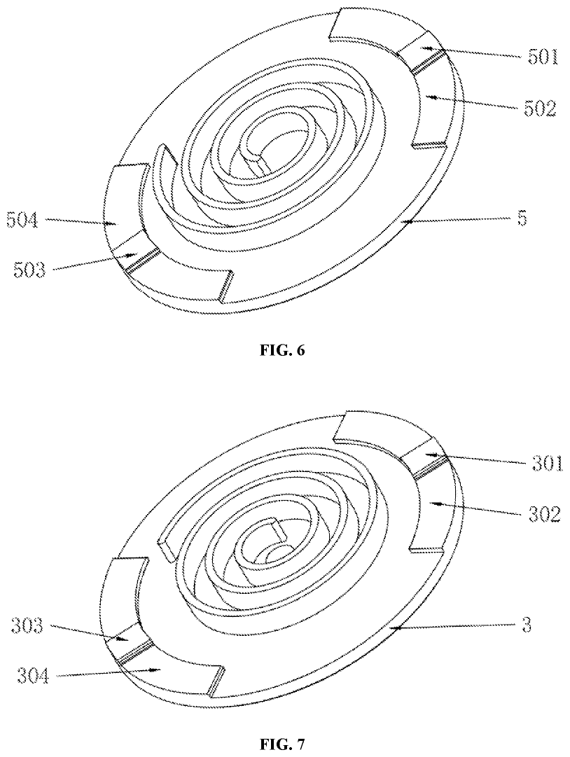

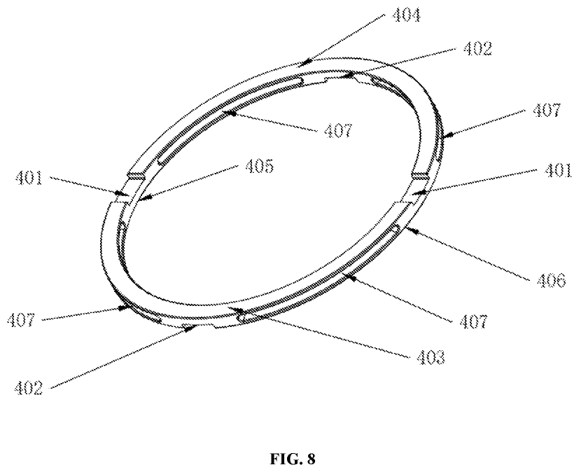

As shown in FIG. 1 to FIG. 8, an energy recovery type scroll compressor is provided. The energy recovery type scroll compressor includes a scroll compression mechanism, a driving mechanism and a scroll expansion mechanism. Preferably, the scroll compression mechanism and the scroll expansion mechanism are both autorotating scroll structures. One end of a motor shaft 703 of the driving mechanism is in key transmission connection with the scroll compression mechanism, and the other end of the motor shaft 703 of the driving mechanism is in key transmission connection with the scroll expansion mechanism. The scroll expansion mechanism includes a loaded scroll plate 5 and an unloaded scroll plate 3. The motor shaft 703 of the driving mechanism is in transmission connection with the loaded scroll plate 5. An air intake hollow shaft 1 centrally provided with an air inlet is arranged at one end, away from the loaded scroll plate 5, of the unloaded scroll plate 3. The air inlet communicates with an expansion end high-pressure working medium channel a. An expansion cavity of the scroll expansion mechanism communicates with an expansion end low-pressure working medium channel b. A high-pressure working medium enters the scroll expansion mechanism through the air inlet, and gas force drives the loaded scroll plate 5 to move together with the unloaded scroll plate 3. The loaded scroll plate 5 is in flat key connection transmission with the motor shaft 703 to drive the motor shaft 703 to rotate instead of a portion of the motor to do work, that is, the pressure energy of the high-pressure working medium is converted into the rotation of the scroll expansion mechanism by conveying the high-pressure working medium to the scroll expansion mechanism, and then the motor shaft 703 of the driving mechanism is driven to rotate. The energy consumption when the drive mechanism drives the scroll compression mechanism to work can be reduced. Equivalently, the pressure energy is matched with the electric energy of the driving motor to drive the scroll compression mechanism to move, such that the recovery of the pressure energy of the high-pressure working medium is realized, the power consumption of the driving mechanism is also reduced, and the energy utilization rate is improved.

When the working medium does not affect the normal operation of the inner structure of the driving mechanism, and the temperature of the expanded working medium is lower than that of the motor, the expansion cavity can be arranged to communicate with the inner cavity of the driving mechanism. The expansion end low-pressure working medium channel b communicates with the expansion cavity through the inner cavity of the driving mechanism, such that the throttling expanded working medium flows through the internal portions of the driving mechanism to take away heat generated when the internal portions work, such that the cooling problem of the internal motor of the driving mechanism is solved, the service life of the motor is prolonged, and the energy is saved without the introduction of external cooling equipment.

In the embodiment, the scroll compression mechanism, the driving mechanism and the scroll expansion mechanism are sequentially arranged from top to bottom, and a fixed support 16 is arranged at the bottom of the scroll expansion mechanism to reduce the transverse space occupation.

In the embodiment, the scroll compression mechanism includes a compressor pressure-stabilizing shell 14, a driving scroll plate 9, a transmission slip ring 10 and a driven scroll plate 11. The compressor pressure-stabilizing shell 14 is arranged at one end of the driving mechanism to form a compression cavity with the driving mechanism. The driving scroll plate 9, the transmission slip ring 10 and the driven scroll plate 11 are sequentially arranged in the compression cavity along the direction away from the driving mechanism. The driving scroll plate 9 is in transmission connection with the motor shaft 703 of the driving mechanism. The driving scroll plate 9 is in transmission connection with the driven scroll plate 11 through the transmission slip ring 10. An exhaust hollow shaft 12 is arranged at one end, away from the driving scroll plate 9, of the driven scroll plate 11. The exhaust hollow shaft 12 communicates with a high-pressure exhaust channel d. The compression cavity communicates with a low-pressure air intake channel c. The exhaust hollow shaft 12 is arranged in the compressor pressure-stabilizing shell 14 through a compressor bearing seat. The phase difference between the driving scroll plate 9 and the driven scroll plate 11 is 180° to ensure that the cavity structure formed by the meshing of scroll teeth of the driving scroll plate 9 and the driven scroll plate 11 is always closed. There is a certain eccentric distance between the driving scroll plate 9 and the driven scroll plate 11, and the eccentric distance is the design turning radius of the scroll plate.

A first driving friction surface 902 and a second driving friction surface 904 are oppositely arranged on both sides of scroll teeth of the driving scroll plate 9. A first driving portion 901 in a strip shape is radially arranged on the first driving friction surface 902. A second driving portion 903 in a strip shape is radially arranged on the second driving friction surface 904. A first driven friction surface 1102 and a second driven friction surface 1104 are oppositely arranged on both sides of scroll teeth of the driven scroll plate 11. A first driven portion 1101 in a strip shape is radially arranged on the first driven friction surface 1102. A second driven portion 1103 in a strip shape is radially arranged on the second driven friction surface 1104.

Two first transmission slip ring matching portions 1001 are oppositely formed in an end face, close to the driving scroll plate 9, of the transmission slip ring 10. The two first transmission slip ring matching portions 1001 are respectively matched with the first driving portion 901 and the second driving portion 903. An end face of the transmission slip ring 10 is divided into a first transmission slip ring friction surface 1003 and a second transmission slip ring friction surface 1004 by the two first transmission slip ring matching portions 1001. The first transmission slip ring friction surface 1003 is in contact with the first driving friction surface 902. The second transmission slip friction surface 1004 is in contact with the second driving friction surface 904. Two second transmission slip ring matching portions 1002 are oppositely formed in the other end face, close to the driven scroll plate 11, of the transmission slip ring 10. The two second transmission slip ring matching portions 1002 are respectively matched with the first driven portion 1101 and the second driven portion 1103. The other end face of the transmission slip ring 10 is divided into a third transmission slip ring friction surface 1005 and a fourth transmission slip ring friction surface 1006 by the two second transmission slip ring matching portions 1002. The third transmission slip ring friction surface 1005 is in contact with the first driven friction surface 1102. The fourth transmission slip ring friction surface 1006 is in contact with the second driven friction surface 1104. A plurality of transmission slip ring vent holes 1007 for communicating inside with outside are formed in the transmission slip ring along the radial direction of the transmission slip ring 10. The gas in the compression cavity enters a working cavity between the driving scroll plate 9 and the driven scroll plate 11 through the transmission slip ring vent holes 1007.

The compression cavity is divided into a working cavity and a pressure stabilizing cavity by a bearing seat. The exhaust hollow shaft 12 communicates with the high-pressure exhaust channel d through the pressure stabilizing cavity. The low-pressure air intake channel c communicates with the working cavity. A check valve 13 for preventing gas from flowing backwards is arranged on an end face, located in the pressure stabilizing cavity, of the bearing seat. In the embodiment, the check valve 13 is of a platy structure. The platy structure covers the exhaust hollow shaft 12, and one end of the platy structure is hinged to the bearing seat.

When the autorotating scroll compressor in the embodiment works, the driving scroll plate 9 and the driven scroll plate 11 rotate around the respective central rotating shafts at the same rotational speed. There is a fixed eccentric distance between the central rotating shaft of the driving scroll plate 9 and the central rotating shaft of the driven scroll plate 11. The relative motion between the transmission slip ring 10 and the driving scroll plate 9 and between the transmission slip ring 10 and the driven scroll plate 11 is linear translation in the direction from the first driving portion 901 or the second driving portion 903 to the first transmission slip ring matching portion 1001, and the transport motion of the transmission slip ring 10 is fixed rotation of the driving scroll plate 9, such that the absolute motion of the transmission slip ring 10 is resultant motion of the relative motion and the transport motion. When the driving scroll plate 9 and the driven scroll plate 11 rotate at the same rotational speed and fixed eccentric distance, one scroll plate (the driving scroll plate 9) is taken as a reference scroll plate, the relative angular velocity of the other scroll plate (the driven scroll plate 11) is always zero and the direction of the eccentric distance is constantly changing, that is, the reference scroll plate (the driving scroll plate 9) is fixed and the other scroll plate (the driven scroll plate 11) is in translation around the fixed eccentric distance. The motion mode is consistent with that of a revolution scroll compressor.

In the embodiment, the specific structure of the scroll expansion mechanism includes an expander pressure-stabilizing shell 15, a loaded scroll plate 5, a limit slip ring 4 and an unloaded scroll plate 3. The expander pressure-stabilizing shell 15 is arranged at one end of the driving mechanism to form the expansion cavity with the driving mechanism. The loaded scroll plate 5, the limit slip ring 4 and the unloaded scroll plate 3 are sequentially arranged in the expansion cavity along the direction away from the driving mechanism. The loaded scroll plate 5 is in transmission connection with the motor shaft 703 of the driving mechanism. The loaded scroll plate 5 is in transmission connection with the unloaded scroll plate 3 through the limit slip ring 4. The phase difference between the loaded scroll plate 5 and the unloaded scroll plate 3 is 180° to ensure that the cavity structure formed by the meshing of scroll teeth of the loaded scroll plate 5 and the unloaded scroll plate 3 is always closed. There is a certain eccentric distance between the loaded scroll plate 5 and the unloaded scroll plate 3, and the eccentric distance is the design turning radius of the scroll plate.

A first loaded friction surface 502 and a second loaded friction surface 504 are oppositely arranged on both sides of scroll teeth of the loaded scroll plate 5. A first loaded portion 501 in a strip shape is radially arranged on the first loaded friction surface 502. A second loaded portion 503 in a strip shape is radially arranged on the second loaded friction surface 504. A first unloaded friction surface 302 and a second unloaded friction surface 304 are oppositely arranged on both sides of scroll teeth of the unloaded scroll plate 3. A first unloaded portion 301 in a strip shape is radially arranged on the first unloaded friction surface 302. A second unloaded portion 303 in a strip shape is radially arranged on the second unloaded friction surface 304.

Two first limit slip ring matching portions 401 are oppositely formed in an end face, close to the loaded scroll plate 5, of the limit slip ring 4. The two first limit slip ring matching portions 401 are respectively matched with the first loaded portion 501 and the second loaded portion 503. The end face of the limit slip ring 4 is divided into a first limit slip ring friction surface 403 and a second limit slip ring friction surface 404 by the two first limit slip ring matching portions 401. The first limit slip ring friction surface 403 is in contact with the first loaded friction surface 502. The second limit slip friction surface 404 is in contact with the second loaded friction surface 504. Two second limit slip ring matching portions 402 are oppositely formed in the other end face, close to the unloaded scroll plate 3, of the limit slip ring 4. The two second limit slip ring matching portions 402 are respectively matched with the first unloaded portion 301 and the second unloaded portion 303. The other end face of the limit slip ring 4 is divided into a third limit slip ring friction surface 405 and a fourth limit slip ring friction surface 406 by the two second limit slip ring matching portions 402. The third limit slip ring friction surface 405 is in contact with the first unloaded friction surface 302. The fourth limit slip ring friction surface 406 is in contact with the second unloaded friction surface 304. Multiple limit slip ring vent holes 407 for communicating inside with outside are formed in the limit slip ring along the radial direction of the limit slip ring 4. The gas in the expansion end high-pressure working medium channel a enters the expansion cavity sequentially through the air intake hollow shaft 1, the cavity between the scroll teeth and the limit slip ring vent holes 407.

The air intake hollow shaft 1 is arranged in the expansion cavity through the expansion bearing seat 2. The expansion cavity is divided into a working cavity and an air inlet cavity by the expansion bearing seat 2. The air intake hollow shaft 1 communicates with the expansion end high-pressure working medium channel a through the air inlet cavity. The expansion end low-pressure working medium channel b communicates with the working cavity through the cavity of the driving mechanism.

The working principle of the scroll expansion mechanism is similar to that of the scroll compression mechanism, and the air inlet direction is changed. Specifically, the loaded scroll plate 5 and the unloaded scroll plate 3 rotate around the respective central rotating shafts at the same rotational speed. There is a fixed eccentric distance between the central rotating shaft of the loaded scroll plate 5 and the central rotating shaft of the unloaded scroll plate 3. The relative motion between the transmission slip ring 4 and the loaded scroll plate 5 and between the transmission slip ring 4 and the unloaded scroll plate 3 is linear translation in the direction from the first driving portion 501 or the second driving portion 503 to the first transmission slip ring matching portion 401, and the transport motion of the transmission slip ring 4 is fixed rotation of the loaded scroll plate 5, such that the absolute motion of the transmission slip ring 4 is resultant motion of the relative motion and the transport motion.

The first driving portion 901 and the second driving portion 903 are bosses, and the first transmission slip ring matching portion 1001 is a sliding chute. Or, the first driving portion 901 and the second driving portion 903 are sliding chutes, and the first transmission slip ring matching portion 1001 is a boss. The first driven portion 1101 and the second driven portion 1103 are bosses, and the second transmission slip ring matching portion 1002 is a sliding chute. Or, the first driven portion 1101 and the second driven portion 1103 are sliding chutes, and the second transmission slip ring matching portion 1002 is a boss. The first loaded portion 501 and the second loaded portion 503 are bosses, and the first limit slip ring matching portion 401 is a sliding chute. Or, the first loaded portion 501 and the second loaded portion 503 are sliding chutes, and the first limit slip ring matching portion 401 is a boss. The first unloaded portion 301 and the second unloaded portion 303 are bosses, and the second limit slip ring matching portion 402 is a sliding chute. Or, the first unloaded portion 301 and the second unloaded portion 303 are sliding chutes, and the second limit slip ring matching portion 402 is a boss.

The driving scroll plate 9, the transmission slip ring 10, the driven scroll plate 11, the loaded scroll plate 5, the limit slip ring 4 and the unloaded scroll plate 3 are all sprayed with self-lubricating coatings. The coatings can effectively lubricate the driving scroll plate, the driven scroll plate 11 and the transmission slip ring 10 of the scroll compression mechanism as well as the loaded scroll plate 5, the unloaded scroll plate 3 and the limit slip ring 4 of the scroll expansion mechanism, and the coatings can reduce the meshing clearance between the driving scroll plate 9 and the driven scroll plate 11 of the scroll compressor, such that the leakage rate is reduced, and the compression efficiency is improved.

The driving structure specifically includes a motor shell 8, a motor stator 701, a motor rotor 702 and a motor shaft 703 arranged from outside to inside. The top and the bottom of the motor shell 8 are respectively provided with a top bearing seat and a bottom bearing seat 6, and both ends of the motor shaft 703 is rotatably provided in the two bearing seats.

### Embodiment II

The embodiment discloses a carbon dioxide heat pump system using the energy recovery type scroll compressor in the first embodiment. A regenerator high-pressure side working medium outlet of the carbon dioxide heat pump system communicates with the expansion end high-pressure working medium channel a, an evaporator working medium inlet of the carbon dioxide heat pump system communicates with the expansion end low-pressure working medium channel b, a regenerator low-pressure side working medium outlet of the carbon dioxide heat pump system communicates with the low-pressure air intake channel c of the scroll compression mechanism, and a cooler working medium inlet of the carbon dioxide heat pump system communicates with the high-pressure exhaust channel d of the scroll compression mechanism.

Specifically, the high-pressure carbon dioxide working medium passing through a cooler and a regenerator enters the scroll expansion mechanism through the expansion end high-pressure working medium channel a, and enters the expansion cavity through the air intake hollow shaft of the scroll expansion mechanism to expand and do work. The expanded low-pressure carbon dioxide working medium flows through the motor to absorb heat and then is discharged from the expansion end low-pressure working medium channel b to enter an evaporator. The carbon dioxide working medium passing through the evaporator and the regenerator enters the scroll compression mechanism through the low-pressure air intake channel c for compression, and the compressed carbon dioxide working medium is discharged into the cooler through the high-pressure air exhaust channel d.

The energy recovery type scroll compressor is arranged in the carbon dioxide heat pump system to replace a throttle valve to work. The temperature of the motor is higher than that of the outside air of the evaporator. The heat exchange efficiency through the motor is higher, and the overall heat exchange efficiency is improved. That is, the waste heat of the motor is recovered to improve the heat exchange efficiency, the working efficiency of the system is improved, and the energy consumption of the whole unit is reduced. Because the energy recovery type scroll compressor is of a vertical structure, the carbon dioxide working medium is in a gas-liquid two-phase state after expansion by an expander. Due to the density difference, liquid-phase carbon dioxide is in the lower portion and gas-phase carbon dioxide is in the upper portion, such that gas-liquid separation of carbon dioxide is realized.

Adaptive changes made according to actual requirements are all within the protection range of the present disclosure.

It needs to be noted that for those skilled in the art, obviously the present disclosure is not limited to the details of the exemplary embodiment, and the present disclosure can be achieved in other specific forms without departing from the spirit or essential characteristics of the present disclosure. Therefore, for every point, the embodiments should be regarded as exemplary embodiments and are unrestrictive, the scope of the present disclosure is restricted by the claims appended hereto, and therefore, all changes, including the meanings and scopes of equivalent elements, of the claims are aimed to be included in the present disclosure. Any mark of drawings in the claims should not be regarded as limitation to the involved claims.

Specific examples are used for illustration of the principles and implementation methods of the present disclosure. The description of the above-mentioned embodiments is used to help illustrate the method and its core principles of the present disclosure. In addition, those skilled in the art can make various modifications in terms of specific embodiments and scope of application in accordance with the teachings of the present disclosure. In summary, the contents of this specification should not be understood as the limitation of the present disclosure.

1. An energy recovery type scroll compressor, comprising a scroll compression mechanism, a driving mechanism and a scroll expansion mechanism, wherein one end of a motor shaft of the driving mechanism is in transmission connection with the scroll compression mechanism, and an other end of the motor shaft of the driving mechanism is in transmission connection with the scroll expansion mechanism, the scroll expansion mechanism comprises a loaded scroll plate and an unloaded scroll plate, the motor shaft of the driving mechanism is in transmission connection with the loaded scroll plate, an air intake hollow shaft centrally provided with an air inlet is arranged at one end, away from the loaded scroll plate, of the unloaded scroll plate, the air inlet communicates with an expansion end high-pressure working medium channel, and an expansion cavity of the scroll expansion mechanism communicates with an expansion end low-pressure working medium channel.

2. The energy recovery type scroll compressor according to claim 1, wherein the expansion cavity communicates with an inner cavity of the driving mechanism, and the expansion end low-pressure working medium channel communicates with the expansion cavity through the inner cavity of the driving mechanism.

3. The energy recovery type scroll compressor according to claim 1, wherein the scroll compression mechanism, the driving mechanism and the scroll expansion mechanism are sequentially arranged from top to bottom, and a fixed support is arranged at a bottom of the scroll expansion mechanism.

4. The energy recovery type scroll compressor according to claim 1, wherein the scroll compression mechanism is an autorotating scroll compression mechanism, and the scroll expansion mechanism is an autorotating scroll expansion mechanism.

5. The energy recovery type scroll compressor according to claim 4, wherein the scroll compression mechanism comprises a compressor pressure-stabilizing shell, a driving scroll plate, a transmission slip ring and a driven scroll plate, the compressor pressure-stabilizing shell is arranged at one end of the driving mechanism to form a compression cavity with the driving mechanism, the driving scroll plate, the transmission slip ring and the driven scroll plate are sequentially arranged in the compression cavity along a direction away from the driving mechanism, the driving scroll plate is in transmission connection with the motor shaft of the driving mechanism, the driving scroll plate is in transmission connection with the driven scroll plate through the transmission slip ring, an exhaust hollow shaft is arranged at one end, away from the driving scroll plate, of the driven scroll plate, the exhaust hollow shaft communicates with a high-pressure exhaust channel, the compression cavity communicates with a low-pressure air intake channel, the exhaust hollow shaft is arranged in the compressor pressure-stabilizing shell through a compressor bearing seat, and a phase difference between the driving scroll plate and the driven scroll plate is 180°;
a first driving friction surface and a second driving friction surface are oppositely arranged on both sides of scroll teeth of the driving scroll plate, a first driving portion in a strip shape is radially arranged on the first driving friction surface, a second driving portion in a strip shape is radially arranged on the second driving friction surface, a first driven friction surface and a second driven friction surface are oppositely arranged on both sides of scroll teeth of the driven scroll plate, a first driven portion in a strip shape is radially arranged on the first driven friction surface, and a second driven portion in a strip shape is radially arranged on the second driven friction surface;
two first transmission slip ring matching portions are oppositely formed in an end face, close to the driving scroll plate, of the transmission slip ring, the two first transmission slip ring matching portions are respectively matched with the first driving portion and the second driving portion, the end face of the transmission slip ring is divided into a first transmission slip ring friction surface and a second transmission slip ring friction surface by the two first transmission slip ring matching portions, the first transmission slip ring friction surface is in contact with the first driving friction surface, the second transmission slip friction surface is in contact with the second driving friction surface, two second transmission slip ring matching portions are oppositely formed in an other end face, close to the driven scroll plate, of the transmission slip ring, the two second transmission slip ring matching portions are respectively matched with the first driven portion and the second driven portion, the other end face of the transmission slip ring is divided into a third transmission slip ring friction surface and a fourth transmission slip ring friction surface by the two second transmission slip ring matching portions, the third transmission slip ring friction surface is in contact with the first driven friction surface, the fourth transmission slip ring friction surface is in contact with the second driven friction surface, and a plurality of transmission slip ring vent holes for communicating inside with outside are formed in the transmission slip ring along a radial direction of the transmission slip ring.

6. The energy recovery type scroll compressor according to claim 5, wherein each of the driving scroll plate, the transmission slip ring and the driven scroll plate is sprayed with a self-lubricating coating.

7. The energy recovery type scroll compressor according to claim 5, wherein the compression cavity is divided into a working cavity and a pressure stabilizing cavity by the bearing seat, the exhaust hollow shaft communicates with the high-pressure exhaust channel through the pressure stabilizing cavity, the low-pressure air intake channel communicates with the working cavity, and a check valve for preventing gas from flowing backwards is arranged on an end face, located in the pressure stabilizing cavity, of the bearing seat.

8. The energy recovery type scroll compressor according to claim 4, wherein the scroll expansion mechanism comprises an expander pressure-stabilizing shell, the loaded scroll plate, a limit slip ring and the unloaded scroll plate, the expander pressure-stabilizing shell is arranged at one end of the driving mechanism to form the expansion cavity with the driving mechanism, the loaded scroll plate, the limit slip ring and the unloaded scroll plate are sequentially arranged in the expansion cavity along the direction away from the driving mechanism, the loaded scroll plate is in transmission connection with the motor shaft of the driving mechanism, the loaded scroll plate is in transmission connection with the unloaded scroll plate through the limit slip ring, and a phase difference between the loaded scroll plate and the unloaded scroll plate is 180°;
a first loaded friction surface and a second loaded friction surface are oppositely arranged on both sides of scroll teeth of the loaded scroll plate, a first loaded portion in a strip shape is radially arranged on the first loaded friction surface, a second loaded portion in a strip shape is radially arranged on the second loaded friction surface, a first unloaded friction surface and a second unloaded friction surface are oppositely arranged on both sides of scroll teeth of the unloaded scroll plate, a first unloaded portion in a strip shape is radially arranged on the first unloaded friction surface, and a second unloaded portion in a strip shape is radially arranged on the second unloaded friction surface;
two first limit slip ring matching portions are oppositely formed in an end face, close to the loaded scroll plate, of the limit slip ring, the two first limit slip ring matching portions are respectively matched with the first loaded portion and the second loaded portion, the end face of the limit slip ring is divided into a first limit slip ring friction surface and a second limit slip ring friction surface by the two first limit slip ring matching portions, the first limit slip ring friction surface is in contact with the first loaded friction surface, the second limit slip friction surface is in contact with the second loaded friction surface, two second limit slip ring matching portions are oppositely formed in an other end face, close to the unloaded scroll plate, of the limit slip ring, the two second limit slip ring matching portions are respectively matched with the first unloaded portion and the second unloaded portion, the other end face of the limit slip ring is divided into a third limit slip ring friction surface and a fourth limit slip ring friction surface by the two second limit slip ring matching portions, the third limit slip ring friction surface is in contact with the first unloaded friction surface, the fourth limit slip ring friction surface is in contact with the second unloaded friction surface, and a plurality of limit slip ring vent holes for communicating inside with outside are formed in the limit slip ring along a radial direction of the limit slip ring.

9. The energy recovery type scroll compressor according to claim 8, wherein each of the loaded scroll plate, the limit slip ring and the unloaded scroll plate is sprayed with a self-lubricating coating.

10. A carbon dioxide heat pump system using the energy recovery type scroll compressor according to claim 1, wherein a regenerator high-pressure side working medium outlet of the carbon dioxide heat pump system communicates with the expansion end high-pressure working medium channel, an evaporator working medium inlet of the carbon dioxide heat pump system communicates with the expansion end low-pressure working medium channel, a regenerator low-pressure side working medium outlet of the carbon dioxide heat pump system communicates with the low-pressure air intake channel of the scroll compression mechanism, and a cooler working medium inlet of the carbon dioxide heat pump system communicates with the high-pressure exhaust channel of the scroll compression mechanism.

11. The carbon dioxide heat pump system using the energy recovery type scroll compressor according to claim 10, wherein the expansion cavity communicates with an inner cavity of the driving mechanism, and the expansion end low-pressure working medium channel communicates with the expansion cavity through the inner cavity of the driving mechanism.

12. The carbon dioxide heat pump system using the energy recovery type scroll compressor according to claim 10, wherein the scroll compression mechanism, the driving mechanism and the scroll expansion mechanism are sequentially arranged from top to bottom, and a fixed support is arranged at a bottom of the scroll expansion mechanism.

13. The carbon dioxide heat pump system using the energy recovery type scroll compressor according to claim 10, wherein the scroll compression mechanism is an autorotating scroll compression mechanism, and the scroll expansion mechanism is an autorotating scroll expansion mechanism.

14. The carbon dioxide heat pump system using the energy recovery type scroll compressor according to claim 13, wherein the scroll compression mechanism comprises a compressor pressure-stabilizing shell, a driving scroll plate, a transmission slip ring and a driven scroll plate, the compressor pressure-stabilizing shell is arranged at one end of the driving mechanism to form a compression cavity with the driving mechanism, the driving scroll plate, the transmission slip ring and the driven scroll plate are sequentially arranged in the compression cavity along a direction away from the driving mechanism, the driving scroll plate is in transmission connection with the motor shaft of the driving mechanism, the driving scroll plate is in transmission connection with the driven scroll plate through the transmission slip ring, an exhaust hollow shaft is arranged at one end, away from the driving scroll plate, of the driven scroll plate, the exhaust hollow shaft communicates with a high-pressure exhaust channel, the compression cavity communicates with a low-pressure air intake channel, the exhaust hollow shaft is arranged in the compressor pressure-stabilizing shell through a compressor bearing seat, and a phase difference between the driving scroll plate and the driven scroll plate is 180°;
a first driving friction surface and a second driving friction surface are oppositely arranged on both sides of scroll teeth of the driving scroll plate, a first driving portion in a strip shape is radially arranged on the first driving friction surface, a second driving portion in a strip shape is radially arranged on the second driving friction surface, a first driven friction surface and a second driven friction surface are oppositely arranged on both sides of scroll teeth of the driven scroll plate, a first driven portion in a strip shape is radially arranged on the first driven friction surface, and a second driven portion in a strip shape is radially arranged on the second driven friction surface;
two first transmission slip ring matching portions are oppositely formed in an end face, close to the driving scroll plate, of the transmission slip ring, the two first transmission slip ring matching portions are respectively matched with the first driving portion and the second driving portion, the end face of the transmission slip ring is divided into a first transmission slip ring friction surface and a second transmission slip ring friction surface by the two first transmission slip ring matching portions, the first transmission slip ring friction surface is in contact with the first driving friction surface, the second transmission slip friction surface is in contact with the second driving friction surface, two second transmission slip ring matching portions are oppositely formed in an other end face, close to the driven scroll plate, of the transmission slip ring, the two second transmission slip ring matching portions are respectively matched with the first driven portion and the second driven portion, the other end face of the transmission slip ring is divided into a third transmission slip ring friction surface and a fourth transmission slip ring friction surface by the two second transmission slip ring matching portions, the third transmission slip ring friction surface is in contact with the first driven friction surface, the fourth transmission slip ring friction surface is in contact with the second driven friction surface, and a plurality of transmission slip ring vent holes for communicating inside with outside are formed in the transmission slip ring along a radial direction of the transmission slip ring.

15. The carbon dioxide heat pump system using the energy recovery type scroll compressor according to claim 14, wherein each of the driving scroll plate, the transmission slip ring and the driven scroll plate is sprayed with a self-lubricating coating.

16. The carbon dioxide heat pump system using the energy recovery type scroll compressor according to claim 14, wherein the compression cavity is divided into a working cavity and a pressure stabilizing cavity by the bearing seat, the exhaust hollow shaft communicates with the high-pressure exhaust channel through the pressure stabilizing cavity, the low-pressure air intake channel communicates with the working cavity, and a check valve for preventing gas from flowing backwards is arranged on an end face, located in the pressure stabilizing cavity, of the bearing seat.

17. The carbon dioxide heat pump system using the energy recovery type scroll compressor according to claim 13, wherein the scroll expansion mechanism comprises an expander pressure-stabilizing shell, the loaded scroll plate, a limit slip ring and the unloaded scroll plate, the expander pressure-stabilizing shell is arranged at one end of the driving mechanism to form the expansion cavity with the driving mechanism, the loaded scroll plate, the limit slip ring and the unloaded scroll plate are sequentially arranged in the expansion cavity along the direction away from the driving mechanism, the loaded scroll plate is in transmission connection with the motor shaft of the driving mechanism, the loaded scroll plate is in transmission connection with the unloaded scroll plate through the limit slip ring, and a phase difference between the loaded scroll plate and the unloaded scroll plate is 180°;
a first loaded friction surface and a second loaded friction surface are oppositely arranged on both sides of scroll teeth of the loaded scroll plate, a first loaded portion in a strip shape is radially arranged on the first loaded friction surface, a second loaded portion in a strip shape is radially arranged on the second loaded friction surface, a first unloaded friction surface and a second unloaded friction surface are oppositely arranged on both sides of scroll teeth of the unloaded scroll plate, a first unloaded portion in a strip shape is radially arranged on the first unloaded friction surface, and a second unloaded portion in a strip shape is radially arranged on the second unloaded friction surface;
two first limit slip ring matching portions are oppositely formed in an end face, close to the loaded scroll plate, of the limit slip ring, the two first limit slip ring matching portions are respectively matched with the first loaded portion and the second loaded portion, the end face of the limit slip ring is divided into a first limit slip ring friction surface and a second limit slip ring friction surface by the two first limit slip ring matching portions, the first limit slip ring friction surface is in contact with the first loaded friction surface, the second limit slip friction surface is in contact with the second loaded friction surface, two second limit slip ring matching portions are oppositely formed in an other end face, close to the unloaded scroll plate, of the limit slip ring, the two second limit slip ring matching portions are respectively matched with the first unloaded portion and the second unloaded portion, the other end face of the limit slip ring is divided into a third limit slip ring friction surface and a fourth limit slip ring friction surface by the two second limit slip ring matching portions, the third limit slip ring friction surface is in contact with the first unloaded friction surface, the fourth limit slip ring friction surface is in contact with the second unloaded friction surface, and a plurality of limit slip ring vent holes for communicating inside with outside are formed in the limit slip ring along a radial direction of the limit slip ring.

18. The carbon dioxide heat pump system using the energy recovery type scroll compressor according to claim 17, wherein each of the loaded scroll plate, the limit slip ring and the unloaded scroll plate is sprayed with a self-lubricating coating.
